(19) United States
(12) Patent Application Publication
(10) Pub. No.: US 2009/0249394 A1
(43) Pub. Date: Oct. 1, 2009

(54) MINI EPG INTERFACE FOR ON-DEMAND AND OTHER CONTENT DATA

(75) Inventors: Mark D. Schwesinger, Bellevue, WA (US); Frederic Azera, Kirkland, WA (US); William H. Vong, Seattle, WA (US); Christen E. Coomer, Seattle, WA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 12/058,504

(22) Filed: Mar. 28, 2008

(51) Int. Cl. G06F 3/00; H04N 7/173

(52) U.S. Cl. 725/39; 725/87; 715/719; 715/721

(57) ABSTRACT

A method and system are disclosed for providing an on-demand mini EPG interface displayed over underlying content. The underlying content may for example be broadcast content. The on-demand mini EPG interface may be populated with discovery data for video-on-demand content which may be selected and organized within the interface based in part on the underlying content.

### BACKGROUND

The convergence of computing and entertainment continues to provide new content and options for consumers. For example, cable subscribers can now access broadcast television programs and video-on-demand content (VOD) through their set-top boxes. In one offering, video-on-demand service allows a user to select a program for viewing from a library of programs, wherein all of the programs are available at any time and can be paused, saved, reviewed, etc. (as opposed to a broadcast television program that is only available at a scheduled time and duration). Other sources of VOD content may also exist, including content from a media library or via the Internet, such as from an Internet Protocol (IP) stream, a Web site, etc. Content streamed or downloaded over the Internet is referred to herein as “broadband” content. All content received via a cable or satellite service provider, or via antenna from a broadcast signal, for display over a television channel at a particular time, is referred to herein as “broadcast” content.

Listings of available programs for a given content source are generated from discovery data (e.g., catalogs of available content). This content is displayed to users over their display via an electronic program guide (EPG). An EPG allows users to manage and navigate through large volumes of program channels and associated information. However, an EPG will typically segregate discovery data from different sources. For example, an EPG may provide cable television listings through one interface and video-on-demand and other broadband content listings through a separate and distinct interface. As such, the user interface for such content provides no relationships, interactions, or cohesive user experiences among content of different sources.

Moreover, the use of an EPG can be intrusive into the user viewing experience. The EPG is typically displayed over content the user is then viewing, or at least takes up the majority of the display, with the content then being viewed relegated to a small portion of the display.

### SUMMARY

Embodiments of the present system relate to methods of providing an on-demand mini EPG interface displayed over underlying content. The underlying content may for example be broadcast or broadband content. The on-demand mini EPG interface may be populated with discovery data for video-on-demand content which, in embodiments, may be selected and organized within the interface based in part on the underlying content. As an example, where the underlying content is broadcast content from a given provider, the on-demand mini EPG interface may present discovery data for video-on-demand content from that provider. A variety of other schemas are contemplated for selecting and organizing the discovery data based on the underlying content. In further embodiments, the on-demand mini EPG interface may be populated with discovery data for content that is selected independently of the underlying content.

The interface preferably takes up a small amount of space on the display so that at least a majority of the underlying content is visible on the display while the interface is active. In embodiments, the interface may be sized to have a length that is approximately ½ the length of the underlying content and a height that is approximately ¼ the height of the underlying content, though this is by way of example only and both the length and height may vary in further embodiments.

In embodiments, when the on-demand mini EPG interface is accessed, the interface displays a single row of discovery data for a number of video-on-demand offerings. One of the offerings is highlighted, or in focus, so that greater detail is provided about that particular offering, including for example the name of the content, a graphical thumbnail from the content, content provider identifier, content duration and/or a URL from where the content was or can be downloaded. Using a selection device such as a remote control or computer input device, a user may select that offering, at which point that content is delivered to the user. A user may alternatively scroll along the row of discovery data in the interface to bring other content in focus.

A user is also able to scroll up and/or down so that other rows of discovery data are displayed on the interface. The discovery data in these additional rows may relate to content from a variety of different sources, including additional video-on-demand content, broadband content other than video-on-demand content, broadcast content and content stored within a local media library. A variety of schemas may be employed for determining what type of discovery data is presented in the additional rows, as well as how it is organized.

### BRIEF DESCRIPTION OF THE DRAWINGS

FIG. 1 is a block diagram of an embodiment for presenting a mini EPG interface according to the present system.

FIG. 2 is a screen shot of an embodiment of a mini EPG interface according to the present system.

FIG. 3 is an enlarged view of the mini EPG interface according to the embodiment shown in FIG. 2.

FIG. 4 is a further block diagram of an embodiment for presenting a mini EPG interface according to the present system.

FIG. 5 is a flowchart for presenting a mini EPG interface according to the present system.

FIG. 6 is a block diagram of a computing environment for presenting a mini EPG interface according to the present system.

### DETAILED DESCRIPTION

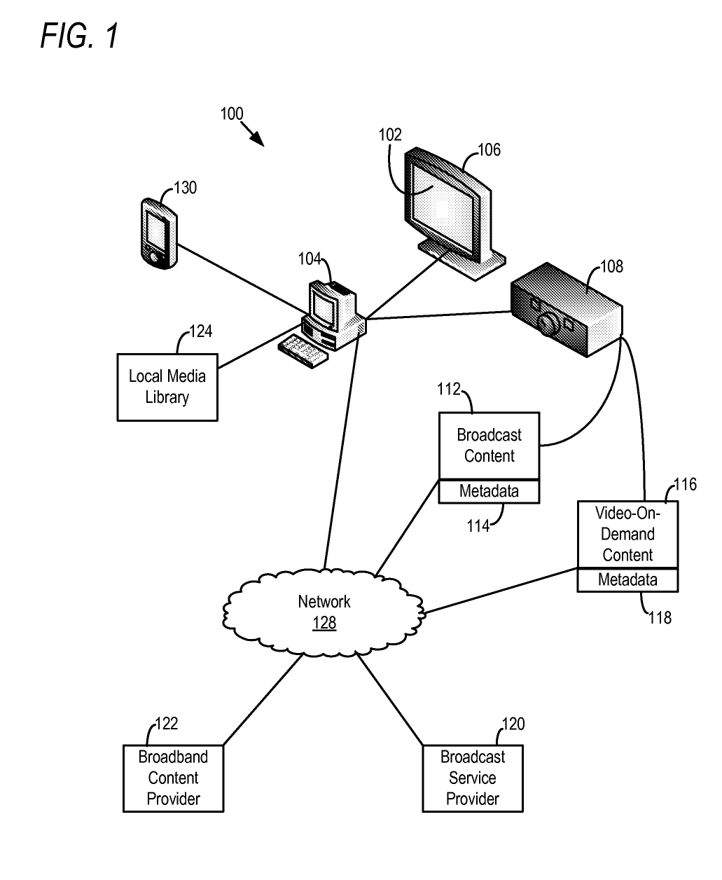

Embodiments of the present system will now be described with reference to FIGS. 1-6, which in general relate to a mini EPG user interface providing video-on-demand (VOD) and other content data to users. FIG. 1 illustrates an example system 100 for presenting discovery data in an on-demand mini EPG interface 102. As used herein, the on-demand mini EPG interface is an EPG user interface that presents data on VOD content only. As explained hereinafter, an alternative mini EPG interface according to the present system may present content other than VOD content. VOD content is available to a user for viewing at any time and may be delivered through a broadband connection or any other delivery network. This is in contrast to broadcast content, which is available at prescribed times.

A user's computing system 104 is coupled to a display device 106, which is capable of presenting the on-demand mini EPG interface 102. The interface 102 provides a graphical user interface that can display program titles and other descriptive information referred to herein as “discovery data.” The computing system 104 is also coupled to a tuner device 108 (e.g., a set-top box or a tuner card internal or external to the computing device), which receives broadcast content 112 and VOD content 116. The broadcast content 112 is received from a broadcast service provider 120. Metadata 114 is also received, from broadcast service provider or other source, describing the broadcast content 112. Metadata 114 may include for example title, synopsis, genre, category, classification, review, cast, crew, artist, producer, time, duration, location, content type, content provider, source, resolution, cost, subscriber, or other data relating to particular media content. Broadcast service provider 120 may be a cable service provider, a satellite service provider and/or airwave-based broadcast television stations. Broadcast providers for other media, such as satellite radio, IP-based radio telecast, etc., may also be supported through computing system 104.

The VOD content 116 may typically be received from a broadband content provider 122 though other sources are possible. The VOD content 116 may also come from other sources, including for example from broadcast service provider 120. Thus, broadcast service provider 120 may provide broadcast content 112 which may be viewed at prescribed times; and broadcast service provider 120 may provide VOD content 116 which may be viewed any time on demand. By the same token, in embodiments, content may be available from broadband service provider 122 that is also VOD content.

The VOD content 116 is received along with metadata 118 describing the VOD content 116. Metadata 118 may include the same classifications of data as metadata 114. The broadcast and VOD content may be received from the respective sources via a communications network 128, which may for example be the Internet. Local media library 124 may alternatively or additionally include a direct connection to computing system 104.

In one embodiment, the computing system 104 executes a media application that manages the user's access to media content, whether available locally or remotely. For example, the user can use his or her computing system 104 to control a portable media player 130, the tuner device 108, the local media library 124, and other content available from discrete devices or over the communications network 128. Examples of the control a user may apply can include, without limitation, transferring content between a portable media player 130 and a local media library 124, scheduling the recording of a cable television program by a digital video recorder (not shown) coupled to the computing system 104, and downloading broadband content (such as a video or song) from broadband content provider 122.

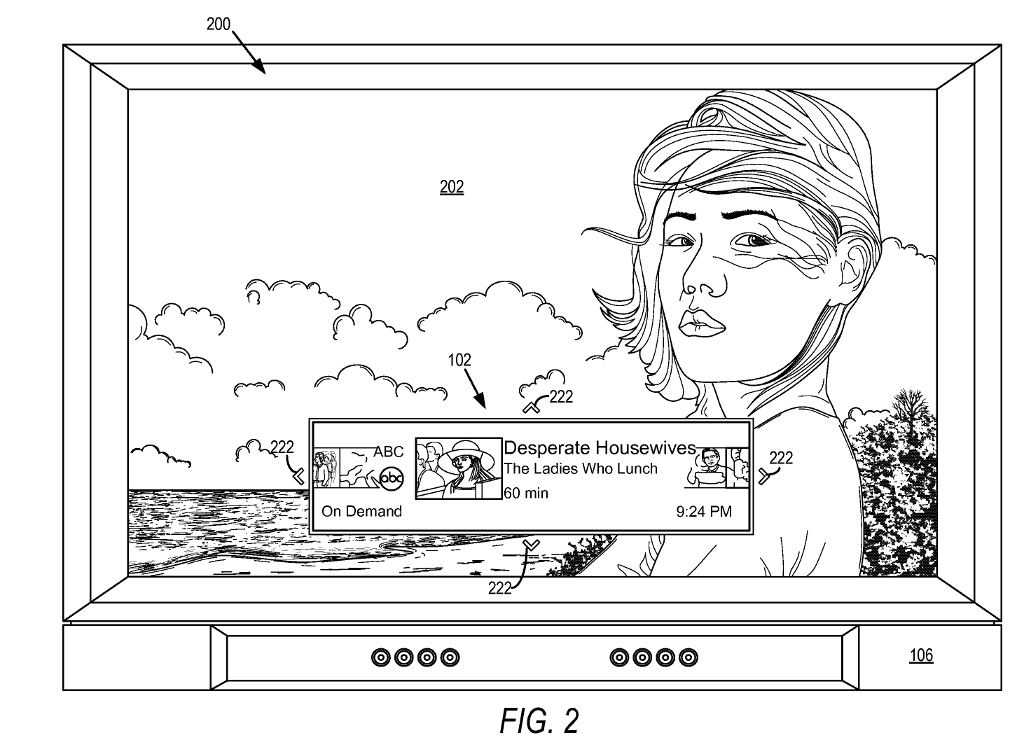

In one implementation, the media application also provides the on-demand mini EPG interface 102 on a display device 106 (e.g., a monitor or television) coupled to the computing device 104. FIG. 2 illustrates a display 106 including an example screenshot 200 including an on-demand mini EPG interface 102. In an embodiment of the present system, the on-demand mini EPG interface 102 presents an on-screen guide showing a user discovery data for the available VOD content. The on-demand mini EPG interface 102 is displayed on top of the underlying content 202 which the user is then viewing in a way that is minimally invasive into the user's viewing experience.

The discovery data that is presented for display by the media application in the mini EPG interface 102 may be selected according to a variety of different schemas as explained hereinafter in more detail. In one embodiment, the discovery data presented for display in the mini EPG interface 102 is based on other popular VOD content from the same content provider (e.g., network) that provides the underlying content 202. In another embodiment, the discovery data presented for display in the mini EPG interface 102 may be related in some other way to the underlying content. These and other schemas for selecting the discovery data in interface 102 are explained hereinafter.

Referring now to FIG. 2, the screenshot 200 includes underlying content 202 the user is viewing, and an on-demand mini EPG interface 102. In embodiments, the underlying content 202 is broadcast content. However, the underlying content 202 may be any type of content, including for example content from broadcast service providers, broadband service providers, a local library, digital video disc, compact disc music, video cassette recorder, etc.

The on-demand mini EPG interface 102 may include discovery data for VOD content, including for example series name 206 (where applicable), episode name 208, thumbnail 210, content provider identifier 212 and content duration 214. It is understood that additional or alternative discovery data may be provided for a given show in interface 102, including for example a URL from where the content was or can be downloaded. Radio and song information may offer other information, such as artist, album, album cover graphics, and track title information. As explained in greater detail below, the interface 102 may be accessed and displayed on display 106 upon actuation of a designated control on the user's input selection device (e.g., a remote control or computer input device such as keyboard or mouse).

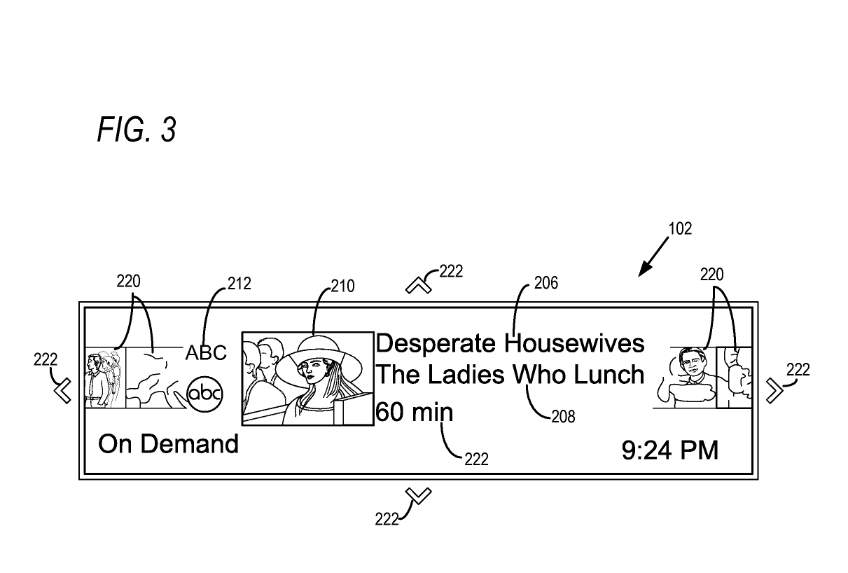

In embodiments, the on-demand mini EPG interface 102 may display a single row, including a plurality of VOD content offerings. However, within the displayed row, the on-demand mini EPG interface 102 may display a single show “in focus,” providing discovery data about that one show. As seen in FIG. 2 and the enlarged view of interface 102 in FIG. 3, the other VOD content offerings in the displayed row may be indicated to the sides of the show then displayed in focus by indicators such as thumbnails 220. The interface 102 includes previous, next, up and down icons 222 to the left, right, above and below the currently in focus discovery data, indicating to a user that more discovery data is available for other content by actuating the appropriate controls on the user's input selection device. Thus, for example, selecting the next icon 222 would scroll the discovery data to the left and bring the discovery data for the next adjacent show in the displayed row into focus. A user can use the on-demand mini EPG interface 102 to navigate, select, and discover content by a variety of parameters, including time, title, channel, genre, cost, actors, directors, sources, relationships to other content, etc. Different schemas are discussed below for selecting and organizing the content for inclusion within the on-demand mini EPG interface 102.

The interface 102 preferably takes up a small amount of space on the display 106 so that a user can view the interface 102 while still viewing and following the underlying content 202. In embodiments, the interface 102 may be sized to have a length that is approximately ½ the length of the underlying content 202 and a height that is approximately ¼ the height of the underlying content 202. It is understood that these ratios are by way of example only and may vary in alternative embodiments above or below that, with the proscription that interface 102 takes up a small amount of space on the display 106 relative to the underlying content 202. The interface 102 may be displayed with a degree of transparency so that the underlying content 202 is completely visible behind the interface 102.

In the embodiment shown, the interface includes a single row of VOD content. It is understood that more than one row of VOD content may be displayed, again with the proscription that interface 102 takes up a small amount of space on the display 106 relative to the underlying content 202. In embodiments, the length and/or width of the interface 102 may be predefined to a set length and/or width, or the length and/or width may be user configurable to an extent.

The VOD content may be presented in the mini EPG interface 102 as being available on a channel, referred to herein as a “virtual channel,” which may be accessed from the mini EPG interface 102 in the same manner as broadcast channels. This enables a consistent and comprehensive discovery experience, associating together content from different sources (e.g., scheduled broadcast television programs, VOD, other available broadband content, other locally stored media, etc.).

In an embodiment, the interface 102 is populated entirely with VOD discovery data. In such an embodiment, the row visible when the interface is accessed may present VOD content information from a single content provider, for example the same content provider as that providing the underlying content 202. As indicated, this content may be broadband or broadcast. Other rows may be available for display upon scrolling upward or downward with the user's input selection device. The discovery data in these other rows may be VOD content information from other VOD content providers, with each row including discovery data from a given provider. Unlike a broadcast content discovery interface, the columns do not represent designated time slots in the on-demand mini EPG interface 102, as all of the displayed content is available on-demand.

In alternative embodiments, it is understood that the mini EPG interface 102 may include discovery data for content other than VOD content. Embodiments of the present system may further provide a mini EPG interface 102 with information including, for example, broadband discovery data other than VOD content, discovery data for local media library 124, discovery data for pay television broadcast content delivery, digital video recorder content, digital video disc content, compact disc music content, video cassette recorder content, platform partner content, longtail content, merchandising and advertising content and other types of remote media content.

In further embodiments, the interface 102 may include an aggregated catalog of discovery data, with some rows presenting information on VOD content, some rows presenting information on other available broadband content, some rows presenting information on broadcast content and/or other rows presenting information on content stored in local media library 124.

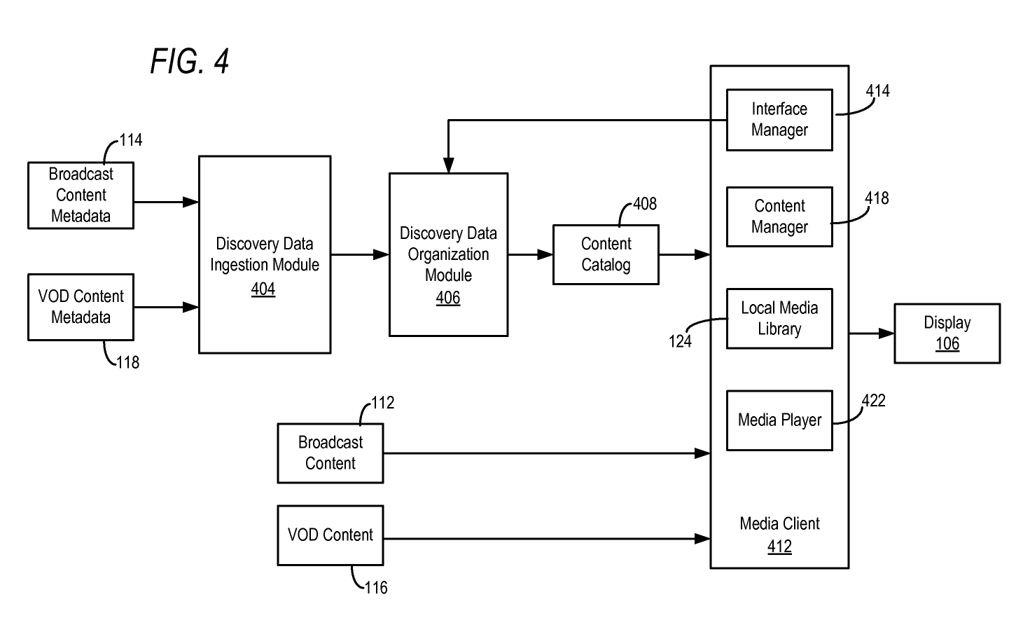

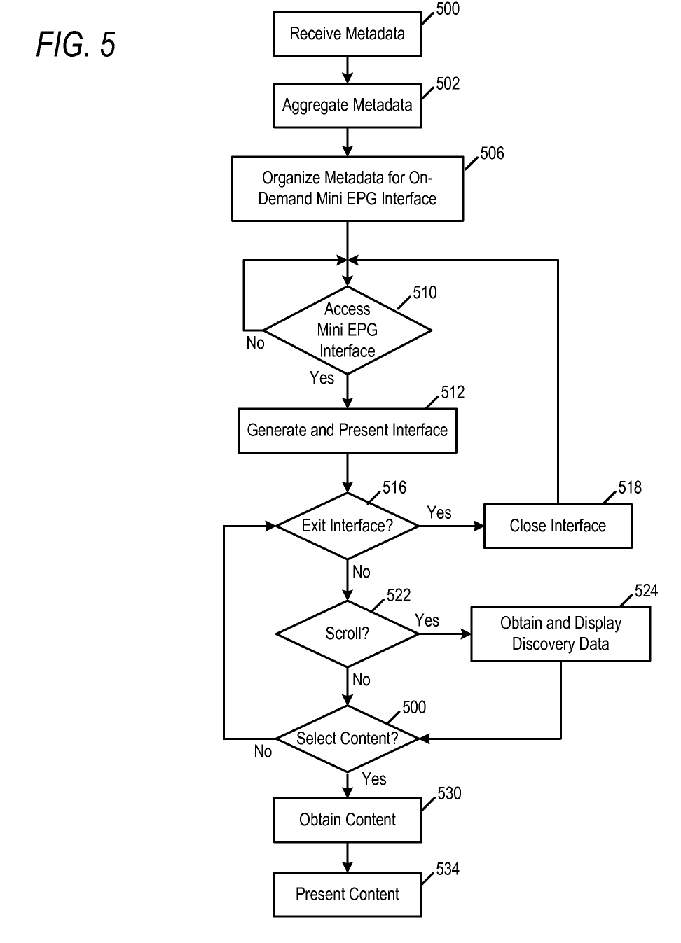

FIG. 4 shows an example implementation of a system 400 for providing an on-demand mini EPG interface 102. Operation of the system 400 is explained with reference to the flowchart of FIG. 5. In an embodiment, the broadcast metadata 114 and the VOD metadata 118 are received within a discovery ingestion module 404 in a step 500. The discovery data ingestion module 404 aggregates the discovery data in step 502 into one or more content compilations. For example, broadcast service providers 120 may provide discovery data specifying programming details available for electronic programming guides. Likewise, available VOD and other broadband content can be collected into catalogs using web crawlers, search engines, predetermined offerings catalogs, etc.

In step 506, an on-demand mini EPG discovery data organization module 406 organizes the metadata for display within the on-demand mini EPG interface 102. The module 406 determines what discovery data is initially displayed within the interface 102 upon accessing interface 102. The module 406 also determines what additional data is provided above, below and to the sides of the displayed discovery data.

Module 406 may organize the aggregated metadata according to a variety of different schemas. In one embodiment, the module 406 may populate the interface 102 from the data aggregated in step 502 based on the underlying content 202 then being viewed by the user. In particular, the step 506 may include the module 406 receiving feedback data from an interface manager 414 about what underlying content is then being displayed over display 106. In this embodiment, based on that underlying content, the discovery data is organized within the interface 102.

The discovery data may be selected and organized based on the underlying content 202 according to a variety of different schemas. In one embodiment, the discovery data presented for display in the mini EPG interface 102 is based on other popular VOD content from the same content provider as the underlying content 202. Thus, for example, if the underlying content is the broadcast show “Lost” from the ABC network, the discovery data presented in the initially displayed row in interface 102 may be the most popular VOD content from ABC.com. The discovery data above and below the displayed row, once scrolled to, may display discovery data from other broadband and/or broadcast content providers. For example, in one embodiment, the most popular on-demand content from other broadband providers may be presented above and/or below the currently displayed row in interface 102. Alternatively or additionally, the content in other rows may be scheduled programming for other shows from the network of the underlying content 202, as well as from other broadcast content providers.

In another embodiment, the discovery data presented for display in the mini EPG interface 102 may be based on the underlying content in some other way. In one such embodiment, metrics data may be used to link certain broadcast and/or VOD content together. Thus, when a user accesses the interface 102 while viewing particular underlying content 202, the on-demand mini EPG interface 102 may present VOD content which has been determined to have some correlation to the underlying content. The correlation may be based on age groups, by show type, by gender, by actor and/or by a variety of other classification metrics. The correlation may be determined by the viewing habits of a group of viewers, or by considering the viewing habits of the particular user.

The content in rows above and below the initially displayed row in this embodiment may be content linked to the underlying content according to other classification metrics. Thus, in this embodiment, the initially displayed row may include other shows which have a correlation to the underlying content based on age. A row above/below the initially displayed row may include data correlated to the underlying content by gender. Another row above/below may include data correlated to the underlying content by actor. Another row above/below may include data correlated to the underlying content by show type, etc. Moreover, in embodiments, a user may provide preference information to the system, which is then used as the criteria for selecting and organizing content within interface 102.

Other factors may be used to determine the organization of discovery data within on-demand mini EPG interface 102. Such other factors include but are not limited to appropriateness to the time slot of the user's underlying content 202, compliance with parental controls set on the computing system and paid-for/sponsored-positioning within the interface 102. Once the discovery data has been selected and organized by the organization module in step 506, the discovery data can then be combined into a content catalog 408 for display and activation within the on-demand mini EPG interface 102 as explained below.

It is understood in the above described embodiments that the discovery data selected and organized by the organization module 406 may change when the organization module 406 receives notification from the interface manager 414 that the underlying content 202 has changed. In further embodiments, the organization module 406 may select discovery data based on schemas which do not take into consideration the underlying content. For example, each row in the interface 102 may simply be the most popular VOD content available from different content providers. Other schemas that are unrelated to the underlying content 202 are possible.

In one embodiment, the discovery data from organization module 406 may be integrated into a compilation, such as content catalog 408 for access by a media client 412. In such an implementation, the catalog 408 may be downloaded to the media client for use in presenting discovery data via the on-demand mini EPG interface 102. The content catalog 408 may, for example, contain metadata that defines an actual media content source, such as a unique identifier for that content, a source type (e.g., broadcast or broadband), and a method or protocol for accessing or retrieving the metadata (e.g., a tuning request for a live television program or an HTTP GET request and a URL to the content on an Internet server for broadband content).

If and when a user accesses the on-demand mini EPG interface 102 in a step 510 (using their input selection device), the interface 102 may be generated and presented by the interface manager 414 in step 512, and the discovery data from the content catalog 408 may be displayed within interface 102. Once the interface 102 is displayed over the underlying content 202, the user has several options. The user can elect to exit the interface 102 in a step 516. If so, the interface 102 closes in step 518, and returns to the display of the underlying content 202 alone. The user also has the option of using the icons 222 to scroll left, right, up and/or down within the interface 102. If the user elects to scroll in step 522, the interface manager 414 obtains the additional discovery data from the content catalog 408 for display in step 524.

The user may also find content within interface 102 that they wish to view. If a user selects particular VOD content from the on-demand mini EPG interface 102 in step 528, the content is obtained in step 530 and displayed in step 534. In one embodiment, this may be accomplished by the interface manager 414 accessing the metadata associated with the selected content from the content catalog 408, using for example an ID reference, and launching the appropriate content retrieval function based on its source type and access method. In particular, content manager module 418 receives the VOD content 116 and presents the content media to a media player module 422 and then ultimately to the user on the display 106. The content manager module 418 may, for example, receive the VOD content from the local media library 124 and/or content sources associated with one or more of the content providers such as broadband content provider 122 and/or broadcast content provider 120.

The content catalog 408 may also include metadata that allows the media client 412 to determine which promotional link is displayed (e.g., on a broadcast or other channel). For example, if a user selects the show Lost from channel 4, the content manager 418 directs an NTSC tuner to receive the Lost broadcast. Likewise, if the user selects the Desperate Housewives episode from ABC.com, the content manager 418 establishes an appropriate video stream from the specified URL. If the user selects to purchase the episode of Desperate Housewives, for example from CinemaNow or Movielink, the content manager 418 initiates a download from the specified URL.

In one embodiment, the content catalog 408 includes a source field for each discovery data entry. The source field may indicate a content delivery type (e.g., broadcast delivery or broadband content delivery), which can be used to direct the content manager 418 to an appropriate source for the selected content. In addition, a promotional link to a promotional portal of the content provider can also be matched to the source field of the content catalog 408. For example, an ABC source field may be used to map ABC promotional links to ABC content. The interface manager 414 of the media client 412 may also be used to determine which, if any, of the channels should receive a promotional link to a promotional portal. For example, the promotional link may only be used for the first affiliated channel in the discovery interface or only for the local affiliate, if multiple affiliates are included in the interface. In addition, the interface manager 414 may also be used to block certain promotional links from appearing within the discovery interface, such as where promotion of content is blocked by a content provider.

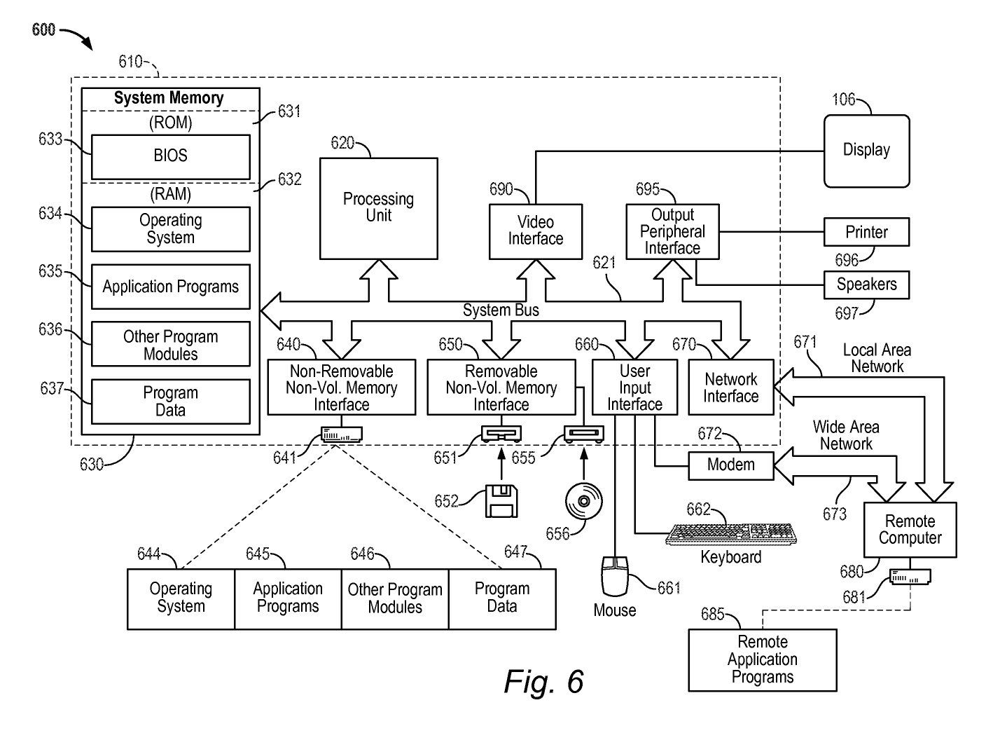

The methods for presenting an on-demand mini EPG interface 102 described herein can be performed on computing system 104, which may be a variety of different processing systems. FIG. 6 illustrates an example of a suitable general computing system environment 600 on which the present system may be implemented. The computing system environment 600 is only one example of a suitable computing environment and is not intended to suggest any limitation as to the scope of use or functionality of the present system. Neither should the computing system environment 600 be interpreted as having any dependency or requirement relating to any one or combination of components illustrated in the exemplary computing system environment 600.

The present system is operational with numerous other general purpose or special purpose computing systems, environments or configurations. Examples of well known computing systems, environments and/or configurations that may be suitable for use with the present system include, but are not limited to, personal computers, server computers, multiprocessor systems, microprocessor-based systems, set top boxes, programmable consumer electronics, network PCs, minicomputers, mainframe computers, laptop and palm computers, hand held devices including smart phones, distributed computing environments that include any of the above systems or devices, and the like.

The present system may be described in the general context of computer-executable instructions, such as program modules, being executed by a computer. Generally, program modules include routines, programs, objects, components, data structures, etc., that perform particular tasks or implement particular abstract data types. The present system may also be practiced in distributed computing environments where tasks are performed by remote processing devices that are linked through a communication network. In a distributed computing environment, program modules may be located in both local and remote computer storage media including memory storage devices.

With reference to FIG. 6, a computing environment for implementing the present system includes a general purpose computing device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVDs) or other optical disk storage, magnetic cassettes, magnetic tapes, magnetic disk storage or other magnetic storage devices, or any other medium which can be used to store the desired information and which can be accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, DVDs, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. These components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus 621, but may be connected by other interface and bus structures, such as a parallel port, game port or a universal serial bus (USB). A monitor 106, discussed above, or other type of display device is also connected to the system bus 621 via an interface, such as a video interface 690. In addition to the monitor 106, computer 610 may also include other peripheral output devices such as speakers 697 and printer 696, which may be connected through an output peripheral interface 695.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communication over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on memory device 681. It will be appreciated that the network connections shown are exemplary and other means of establishing a communications link between the computers may be used.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

We claim:

1. A computer implemented method of providing discovery data for video-on-demand content on a display, comprising the steps of:
(a) displaying an underlying content on the display;
(b) selecting discovery data for video-on-demand content for inclusion in a graphical user interface;
(c) organizing the video-on-demand content discovery data for display in the graphical user interface based at least in part on the underlying content; and
(d) displaying the graphical user interface including at least a portion of the video-on-demand content discovery data organized in said step (c) over the underlying content, at least a majority of the underlying content being visible on the display.

2. A computer implemented method as recited in claim 1, said step (a) of displaying an underlying content on the display comprises the step of displaying broadcast content on the display.

3. A computer implemented method as recited in claim 1, said step (d) of displaying the graphical user interface comprising the step of displaying a single row including discovery data on a plurality of different video-on-demand content offerings.

4. A computer implemented method as recited in claim 2, said step (d) of displaying the graphical user interface comprising the step of displaying discovery data for a first video-on-demand content offering within the row of video-on-demand content offerings in focus.

5. A computer implemented method as recited in claim 4, further comprising the steps (f) of receiving an indication to scroll the discovery data within the graphical user interface left or right, and (g) changing the focus from the first video-on-demand content offering to a second video-on-demand content offering within the displayed row.

6. A computer implemented method as recited in claim 4, further comprising the step (h) of changing the displayed content from the underlying content to the video-on-demand content indicated by the discovery data in focus upon selection of the discovery data in focus.

7. A computer implemented method as recited in claim 1, said step (c) comprising the step of including video-on-demand discovery data in the graphical user interface for content from the same content provider providing the underlying content.

8. A computer implemented method as recited in claim 7, said step (c) comprising the step of including video-on-demand discovery data in the graphical user interface for the most popular content from the same content provider providing the underlying content.

9. A computer implemented method as recited in claim 1, said step (c) comprising the step of including video-on-demand discovery data in the graphical user interface for content having a correlation to the underlying content.

10. A computer implemented method as recited in claim 9, wherein the correlation between the underlying content and the video-on-demand content relates to at least one of a viewer's age, a viewer's gender and content genre.

11. A computer implemented method as recited in claim 1, further comprising the steps (j) of receiving an indication to scroll the displayed discovery data within the graphical user interface up or down, and (k) displaying one or more additional rows of discovery data for additional content.

12. A computer implemented method as recited in claim 11, said step (k) of displaying discovery data for additional content comprises the step of displaying discovery data for at least one of broadcast content, video-on-demand content and content stored in a local library in rows above and/or below the initially displayed row including video-on-demand content.

13. In a computer environment having a display and a user interface selection device, a method of providing a graphical user interface on the display, comprising the steps of:
(a) displaying the graphical user interface over an underlying broadcast content upon actuation of the user interface selection device, at least a majority of the underlying broadcast content being visible on the display; and
(b) populating the graphical user interface with discovery data for at least one of video-on-demand content, broadband content other than video-on-demand content, content stored on a local media library, pay television broadcast content, digital video recorder content, digital video disc content, compact disc music content and video cassette recorder content, the selection and organization of the discovery data based in part on the underlying content.

14. A computer implemented method as recited in claim 13, the graphical user interface displaying a single row, initially including video-on-demand content.

15. A computer implemented method as recited in claim 14, the graphical user interface displaying rows other than the initially displayed row upon receiving a scroll request, the other rows including discovery data for one or more of broadcast content, video-on-demand content, broadband content other than video-on-demand content, content stored on a local media library, pay television broadcast content, digital video recorder content, digital video disc content, compact disc music content and video cassette recorder content, the selection and organization of the discovery data based in part on the underlying content.

16. A computer implemented method as recited in claim 14, the graphical user interface displaying rows other than the initially displayed row upon receiving a scroll request, the other rows including a second row having discovery data for broadcast content and a third row having discovery data for video-on-demand content.

17. A computer implemented method as recited in claim 13, said step (b) comprising the step of populating the graphical user interface with video-on-demand content from the same content provider providing the underlying broadcast content.

18. A computer-readable medium having computer-executable instructions for programming a processor to perform a method of providing discovery data for video-on-demand content on a display, the method comprising the steps of:
(a) displaying a graphical user interface over an underlying content, at least a majority of the underlying content being visible on the display;
(b) populating a first row initially displayed within the graphical user interface with discovery data for video-on-demand content;
(c) receiving a request to scroll the graphical user interface to other rows; and
(d) displaying one or more additional rows after said step (c), the one or more additional rows populated with discovery data for at least one of broadcast content, video-on-demand content, broadband content other than video-on-demand content and content from a local media library.

19. A computer-readable medium as recited in claim 18, said step (b) comprising the step of populating the first row with discovery data selected at least in part based on the underlying content.

20. A computer-readable medium as recited in claim 18, said step (d) comprising the step of displaying two or more additional rows populated with discovery data from at least two of broadcast content, video-on-demand content, broadband content other than video-on-demand content and content from a local media library.
